(19) United States
(12) Patent Application Publication
(10) Pub. No.: US 2013/0282331 A1
(43) Pub. Date: Oct. 24, 2013

(54) DETECTING ABNORMAL BEHAVIOR

(71) Applicants: Ira Cohen, Modiin (IL); Marina Lyan, Modiin (IL); Oded Gazit, Ramat Hsharon (IL); Ohad Assulin, Neve Ilan (IL); Michael Rozman, Rosh Hasin (IL)

(72) Inventors: Ira Cohen, Modiin (IL); Marina Lyan, Modiin (IL); Oded Gazit, Ramat Hsharon (IL); Ohad Assulin, Neve Ilan (IL); Michael Rozman, Rosh Hasin (IL)

(21) Appl. No.: 13/454,572

(22) Filed: Apr. 24, 2012

(51) Int. Cl. G06F 17/18

(52) U.S. Cl. 702/179

(57) ABSTRACT

Systems, methods, and machine-readable and executable instructions are provided for detecting abnormal behavior. Detecting abnormal behavior can include receiving a mean at a previous time interval, a sum of squares at the previous time interval, and a first sample of a metric at a current time interval from a system and adjusting a first weight and a second weight at the current time interval to the first sample and a system change report. Detecting abnormal behavior can also include calculating a mean and a standard deviation of the metric at the current time interval by assigning the first sample the adjusted first weight and by assigning the mean and the sum of squares at a previous time interval the adjusted second weight and detecting abnormal behavior by comparing the first sample to an outlier value based on the mean and the standard deviation at the previous time interval.

### BACKGROUND

Cloud services, be it private or public clouds, are gaining momentum. Maintaining availability and performance of applications running on cloud systems and other types of systems is important in Service Level Agreements (SLA) between cloud consumers and cloud providers. Understanding normal behavior of a metric is important as part of defining Service Level Objectives of SLAs.

### BRIEF DESCRIPTION OF THE DRAWINGS

FIG. 1 illustrates a block diagram of an example method for detecting abnormal behavior according to the present disclosure.

FIG. 2 illustrates a block diagram of an example method for selecting a new season and updating a number of bucket series according to the present disclosure.

FIG. 3 is a flow chart illustrating an example of a method for detecting abnormal behavior according to the present disclosure.

FIG. 4 illustrates a block diagram of an example of a machine-readable medium in communication with processing resources for detecting abnormal behavior according to the present disclosure.

### DETAILED DESCRIPTION

Examples of the present disclosure may include methods and systems for detecting abnormal behavior. An example method for detecting abnormal behavior may include receiving a mean at a previous time interval, a sum of squares at the previous time interval, and a first sample of the metric at a current time interval from a system and adjusting a first weight and a second weight at the current time interval to the first sample and a system change report. Furthermore, an example method for detecting abnormal behavior may include calculating a mean and a standard deviation of the metric at the current time interval by assigning the first sample the adjusted first weight and by assigning the mean and the sum of squares at a previous time interval the adjusted second weight and detecting abnormal behavior by comparing the first sample to an outlier threshold, e.g., outlier value, that can be based on the mean and the standard deviation at the previous time interval.

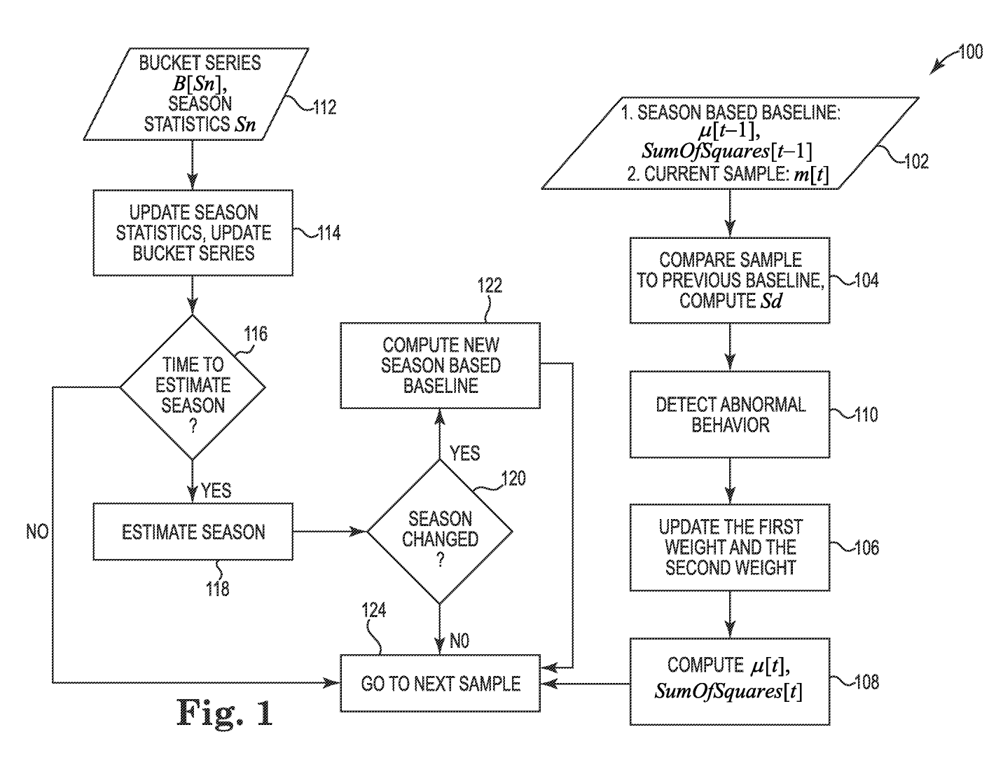

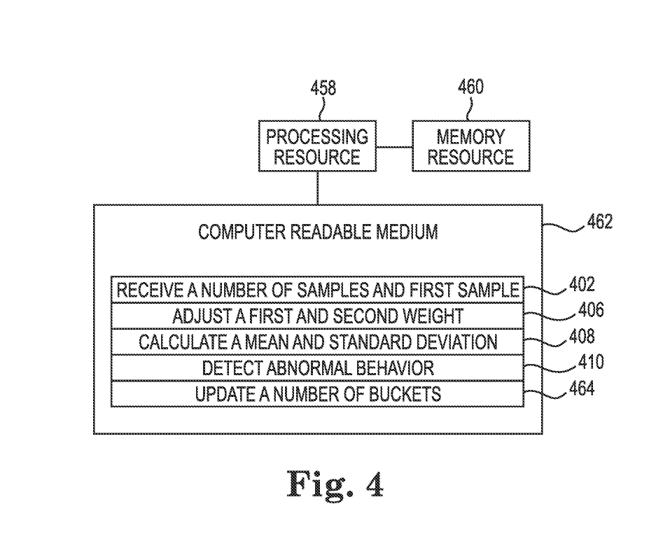

The figures herein follow a numbering convention in which the first digit or digits correspond to the drawing figure number and the remaining digits identify an element or component in the drawing. Similar elements or components between different figures may be identified by the use of similar digits. For example, 106 may reference element “06” in FIG. 1, and a similar element may be referenced as 406 in FIG. 4.

As used herein, “a” or “a number of” something can refer to one or more such things. For example, “a number of widgets” can refer to one or more widgets.

Some previous approaches to detecting abnormal behavior can detect abnormal behavior of a metric by creating a baseline model of normal behavior of a metric from historical measurements of the metric. However, these baseline models incorporate a number of assumptions. The first assumption is that the normal behavior of a metric can change slowly. Furthermore, previous approaches assume that changes in a system, at both the infrastructure and logical level are done at a slow pace. The previously stated assumptions can break down in systems that undergo rapid change in both infrastructure and logic. One such example of a system that undergoes rapid change is a cloud system. In cloud systems changes to the infrastructure can be rapid, with components being added and removed dynamically.

In some examples of the present disclosure, the normal behavior of a metric can be learned and the abnormal behavior of the metric can be detected by monitoring system infrastructure changes and logic changes and by adapting to those changes. The normal behavior of a metric can be based on a normal model of the metric. The normal model of a metric can also be based on seasonal behavior of the metric and on continuous adaptation of what is considered normal behavior.

FIG. 1 illustrates a block diagram 100 of an example method for detecting abnormal behavior according to the present disclosure. In a number of examples of the present disclosure, a system can include any system that monitors normal behavior and/or abnormal behavior. Some examples of a system can include a cloud system or a hybrid cloud system. Furthermore, a system can include any number of systems that generate updates, e.g., samples, of a metric that is being monitored. Examples of a metric can include monitored values of a system such as percent of CPU usage or memory usage. However, a metric is not limited to the previous examples and can include any number of values that are monitored. A metric can also include monitored values of applications, e.g., applications that run on a system, such that an application can function as a system.

The normal behavior of a metric can be modeled by a probability distribution P(m[t]|s, tr) of a metric, m, at a specific time, t, given a season, s, and a trend, tr, such that

P(m[t]|s, tr)˜N(μ_{(s, tr)}, σ_{(s, tr)}|b[t]).

N(μ_{(s, tr)}, σ_{(s, tr)}|b[t]) can denote the normal distribution with a mean, i.e., μ_{(s, tr)}, and a standard deviation, σ_{(s, tr)}, given a bucket, b[t], to which time, t, can be assigned to.

In some examples of the present disclosure, a metric can be modeled with respect to a season and a trend. A trend can include an increase or decrease of a mean value of a metric. A trend can affect a mean of a metric and a standard deviation of a metric. A trend can include a linear increase or decrease of a mean value of a metric. In some examples, a trend can include a different different type of increase or decrease of a mean value of a metric. A trend, for example, can include a logarithmic increase or decrease of a mean value of a metric. A logarithmic increase or decrease of a mean value of a metric can include a increase or decrease of mean value of a metric according to a logarithm function. A trend can affect a mean and a standard deviation by modifying a sample. For example, a sample can be modified according to trend.

A season can include a description of the behavior of a metric such that the seasonal behavior of a metric can be modeled as a season. A seasonal behavior of a metric can include a pattern of a metric that repeats itself in a number of samples of a metric. A season can model the seasonal behavior of a metric through the use of a number of buckets that divide a number of time intervals that span a season. Some examples of a season can include an hourly season, a daily season, and a weekly season although a season can be greater or lower than the previously recited examples. In the example of a daily season, the daily season can include twenty four buckets that are evenly distributed throughout the daily season.

A number of buckets can span a season, and a number of buckets that span a season can be grouped into a set of buckets. A number of buckets in a set of buckets can hold a number of samples of a metric such that the number of samples of a metric can be assigned to specific buckets within a set of buckets. For example, a metric with a half hour reporting frequency can have a daily season with twenty-four buckets such that each bucket can be assigned two samples of the metric.

To determine abnormal behavior at a specific time, e.g., specific time interval, the current sample, m[t], which can include a sample at the current time interval, the mean at the previous time interval, u[t−1], and the sum of squares at the previous time interval, SumofSquares[t−1], are received at 102. That is, constructing a model of abnormal behavior and detecting abnormal can occur without a set of historical data.

At 104, a current sample can be compared to a previous baseline and a number of standard deviations at a previous time interval, sd, can be computed. The comparison and computation can be used to determine if a current sample exhibits abnormal behavior. The comparison and computation can also be performed to determine a first weight and a second weight that can be assigned to the current sample and to the previous samples. That is, the comparison and computation in 104 can be done to determine a first weight and a second weight that can be given to the current sample and the previous samples in defining a normal model of a metric. The normal model of a metric can be created from a mean and a standard deviation. An example of a normal model can include a normal distribution. However, different distributions can be used to model the normal behavior of a metric. The normal model of a metric be updated, e.g., can change, as samples of a metric are received such that a normal distribution that models the normal behavior of a metric can change as samples of a metric are received. That is, a normal distribution can be updated at each time interval.

A baseline can include a mean and a standard deviation at a specific time interval. For example, a previous baseline can include the mean and the standard deviation at a previous time interval. A standard deviation can be computed from a sum of squares. The mean and the standard deviation at a previous time interval can be denoted by μ[t−1] and σ[t−1], respectively. Likewise, a current baseline can include a mean, e.g., μ[t], and a standard deviation, e.g., σ[t], at a current time interval.

Comparing the current sample to a previous baseline can include comparing the current sample to determine if the current sample violates the normal distribution at the previous time interval. The current sample can violate a normal distribution at the previous time interval if the current sample is more than three standard deviations from the mean at the previous time interval, for example. A current sample can violate a normal distribution at the previous time interval if the current sample is considered an outlier. For example, a sample of a metric that is more than three standard deviations from a mean can be considered an outlier. However, other standards of an outlier can be established without departing from the scope of the present disclosure. Violating a normal distribution can indicate that a sample of a metric displays abnormal behavior.

Comparing the current sample to the previous baseline can also include receiving an alert report that the system has changed. Changes to the system can include changes to the system that affect the metric. For example, if a metric includes a central processing unit (CPU) usage then a change to the system can include a change to the CPU usage. The CPU usage metric can be changed by modifying a CPU to include a higher capacity or a lower capacity. The change can affect the metric and the normal model of the metric, e.g., normal distribution. In some examples, a change to the metric, e.g., CPU usage metric, can include a change to system hardware. For example, a single processor can be changed to a number of processors. In a number of examples, a change to the metric can include changing the metric that is being measured. A metric that includes CPU usage can be changed to a metric that reports memory usage and/or network usage.

Change to a metric can include a change to the format that is used to report a sample of a metric. For example, if a metric reports in percentage of use a change can include reporting actual resources used. A change is not limited to hardware change and can include logical changes and other types of changes. The alert reports that are received can be received from any number of places. For example, the alert reports can be received directly from the system or from a third party. Moreover, the alert reports can be learned such that when samples are received a comparison can be made with a baseline to detect possible changes to the system.

A measure of the number of standard deviations that a sample of a metric at the current time interval is from the baseline at the previous time interval can be denoted as sd such that

$$sd = \frac{m [ t ] - μ [ t - 1 ]}{σ [ t - 1 ]} .$$

The standard deviation denoted by σ[t−1] can be derived from the mean at a previous time interval, e.g., μ[t−1], and from the sum of squares at a previous time interval, e.g., SumofSquares[t−1], such that

σ[t−1]=\sqrt{SumOfSquares[t−1]−μ[t−1]²}.

At 110, abnormal behavior can be detected. Abnormal behavior can be defined as a current sample that is greater than a number of standards deviations from a mean of a metric at a previous time interval, e.g., previous baseline mean. A number of standard deviations from a mean can include any number of standard deviations such as three standard deviations, for example, although a number of standard deviations can be larger or smaller than three.

At 106, a first weight and a second weight can be updated. The first weight and the second weight can be used to determine an influence that a sample of a metric at the current time interval can have in calculating the mean of a metric at the current time interval and the sum of squares of a metric at the current time interval. A first weight and a second weight can function as a forgetting factor which determines the rate at which the past samples of a metric are forgotten. Past samples of a metric are forgotten as the influence of the past samples in updating a normal model of a metric is diminished. In a number of examples of the present disclosure, a first weight and a second weight can be updated at each time interval based on the comparison between a sample of a metric at the current time interval and a baseline mean. Furthermore, the first weight and the second weight can have a sum equal to one. For example, if the first weight is equal to 0.5 and the second weight is equal to 0.5 then a sample of the metric at the current time interval can have an influence equal to the influence of a mean and a sum of squares at a previous time interval in calculating a mean and a sum of squares at the current time interval.

The first weight can be denoted by alpha while the second weight can be denoted by 1−alpha. The first weight can increase if an alert report is received indicating that a change has occurred and/or if there are a number of consecutive samples violating a normal model, e.g., normal distribution, of a metric. In some examples, the second weight can be adjusted to decrease when the first weight is adjusted to increase. A number of consecutive samples can violate the normal distribution if the number of consecutive samples are determined to be abnormal at their respective time intervals. In a number of examples of the present disclosure, a number of consecutive samples can be classified as abnormal at their respective time intervals if the number of consecutive samples are more than a threshold value of standard deviations from their respective baseline mean.

A number of consecutive samples can include any number of consecutive samples. That is, a threshold value of consecutive samples can define the number of consecutive samples that are needed to violate the normal distribution. For example, a number of consecutive samples can include three consecutive samples or four consecutive samples, although a greater or smaller number of consecutive samples can be used. The threshold value of consecutive samples can be dependent on the length of a season and on the sample frequency of a metric. The threshold value of consecutive samples, for example, can increase as the season length increases. Similarly, the threshold value of consecutive samples can decrease as the sample frequency of a metric increases.

The first weight can decrease as the distance of a sample from the baseline mean increases. That is, if no alert reports are received indicating that a change has occurred and if a number of consecutive samples do not violate the normal distribution at their respective time intervals then the first weight can decrease as the distance of a sample from the baseline mean increases. As the first weight decreases, the second weight can increase. A decrease of the first weight and/or an increase in the second weight can indicate slower forgetting and/or slower learning.

The first weight can be given as,

$$alpha = \frac{2}{n + 1} .$$

The first weight can be dependent on n which can be a constant representing a past sample of a metric. However, n can change such that in some examples of the present disclosure the first weight, alpha, can depend on the frequency of a metric. For example, as the frequency of a metric increases, e.g., a number of samples per hour increases, then the first weight decreases. Additionally, the first weight can also depend on the season, wherein as the season length decreases the first weight increases.

In a number of examples of the present disclosure,

n=TF(n)·24·F(m)

wherein F(m) can include a frequency, of a metric and TF(n) can include the distance between current time interval and a previous time interval that corresponds to the n sample. The frequency of a metric can be represented as the number of samples per hour. The frequency of a metric can be represented in other formats and the frequency of a metric is not limited to the above examples. The distance from the current time interval, TF(n), can be represented in days such that

$$TF ( n ) = max ( 3 , \frac{season\_length \cdot min\_samples \_in \_bucket}{24 \cdot avg\_samples \_no \_in \_bucket} ) .$$

In a number of examples of the present disclosure, season_length can include the length of a season, min_samples_in_bucket can include the minimum number of samples in a bucket, and avg_samples_no_in_bucket can include the average number of samples in a bucket.

The first weight can decrease as the distance between the current sample of a metric and the previous baseline increases if no alert reports indicating that a change has occurred are received and/or if a number of consecutive samples do not violate the normal distribution at their respective time intervals. The first weight can be updated such that

alpha′=alpha^{min(a,sd-2)}

wherein alpha′ can denote a previously calculated first weight adjusted to the current sample. In min(a,sd−2), a can include a constant that indicates a lower limit on the decrement of the first weight, a can include any number larger than one. That is, a can indicate how small alpha′ can be. Furthermore, a can depend on the definition of an anomaly wherein an anomaly can indicate a sample of a metric that is not considered a change in the normal behavior of a model but that is but that deviates from a baseline mean such that the influence of the sample on alpha′ is lessened.

At 108, the current mean and the current sum of squares can be calculated. The current mean can be defined as,

μ[t]=alpha·m[t]+(1−alpha)·μ[t−1],

which can include the current sample of a metric and the mean at a previous time interval. The sum of squares can be defined as,

SumOfSquares[t]=alpha·m[t]²+(1−alpha)·SumOfSquares[t−1],

which can include the current sample of a metric and the sum of squares at a previous time interval.

At 112, a number of bucket series and a number of season statistics can be provided in selecting a season and in computing a new season based baseline. A number of bucket series can include a bucket series for each of the number of seasons, wherein a bucket series can include a number of buckets and wherein each of the buckets within the number of bucket series can include an average, e.g., mean, of all of the samples of a metric that can be assigned to each of the buckets. For example, if a season includes a daily season with twenty four buckets and if samples of the metric are reported every half hour, then after twenty-four hours of reporting the metric each of the twenty four buckets will be assigned two samples and each of the twenty-four buckets will include an average of their respectively assigned two samples. Season statistics can include a comparison between a number of samples of a metric and a number of seasons, wherein seasons that accurately model the number of samples of a metric can have corresponding season statistics. Seasons that do not accurately model the number of samples of a metric can have season statistics that reflect the same. A season can accurately model a number of samples of a metric as the correlation between a season and the number of samples of a metric increases.

At 114, the season statistics can be updated and the number of bucket series can also be updated based on the current sample of a metric. At 116, it can be determined if a season can be estimated. Estimating a season can include selecting a season. Seasons can be estimated, e.g., selected, periodically or discriminately. A periodic estimation of a season can include estimating a season at a particular time interval. For example, a season can be estimated every number of samples wherein every number of samples can include every five samples or every twenty samples. However, a season can be estimated at a greater number of samples or at a smaller number of samples that the examples given above. A season can also be estimated at particular bucket within a season such that seasons can be estimated at the beginning of the currently selected season, e.g., the first bucket of a season. A discriminate estimation of a season can include estimating a season based on performance or at random.

If it is determined that a season can be estimated, a season can be estimated at 118. Estimating a season can include comparing season statistics that correspond to number of seasons and selecting a season that accurately models a number of samples of a metric. A season can accurately model a number of samples of a metric by having a higher correlation with the number of samples than a number of seasons.

Once a season is selected, at 120 it can be determined if the selected season changed. That is, it can be determined if the selected season after having been estimated at 118 is different than the selected season before being estimated at 118. If the selected season changed, then a new season based baseline can be computed at 122, wherein a season based baseline can include a mean and a sum of squares of a metric at a specific time interval.

A new sample of a metric can be received at 124 if the selected season remained the same. Moreover, a new sample of a metric can be received at 124 if it is not time to estimate a season at 116. Furthermore, a new sample of a metric can be received at after a new season based baseline has been computed.

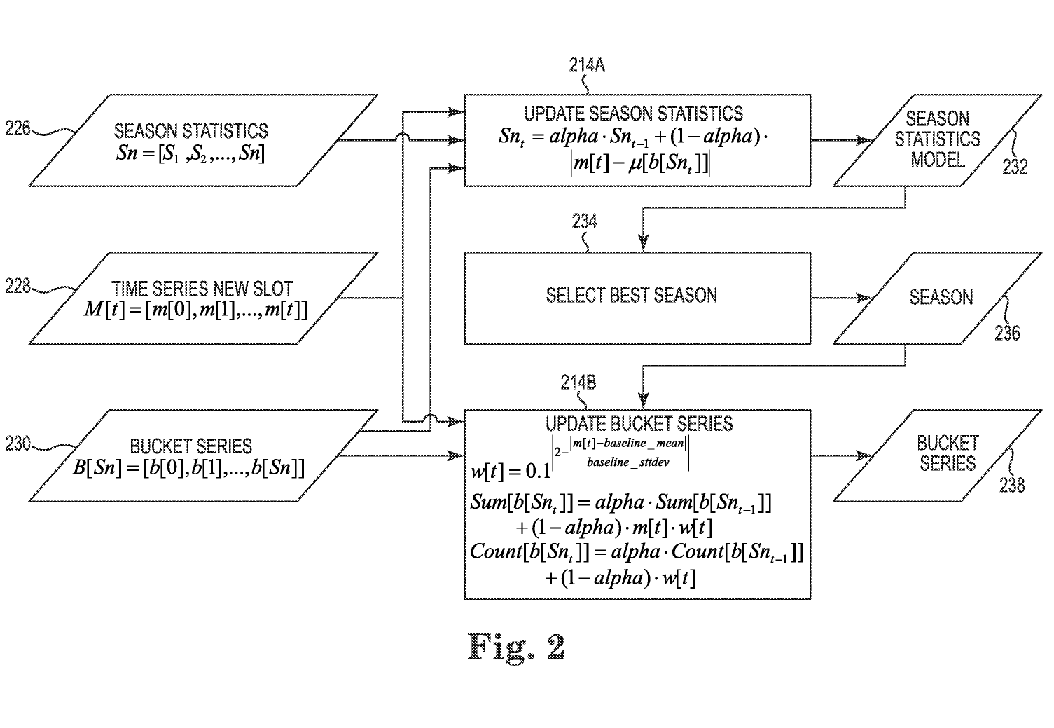

FIG. 2 illustrates a block diagram of an example method for selecting a new season and updating a number of bucket series according to the present disclosure. Season statistics can be updated at 214A using a number of season statistics 226, a sample 228 of the metric at the current time series, and a number of bucket series 230 that correspond to a number of seasons.

In a number of examples of the present disclosure, each season from the number of seasons can have corresponding season statistics 226. For example, a number of season statistics 226 can be denoted as

Sn=[s0, s1, . . . , sn]

such that Sn can be a specific season statistics that corresponds to a specific season. Season statistics can define the correlation between a set of samples of a metric and a season. A number of season statistics 226 can be used to identify and select a season that has a highest correlation with a number of samples of a metric. Furthermore, as the number of samples of a metric increases at 228, the number of season statistics 226 can be used to select a season with the highest correlation with a number of samples of a metric. For example, initially a first season can be identified and selected from a number of seasons based on the first season having the highest level of correlation with a number of samples of a metric from among the number of seasons. In a subsequent identification and selection, after the number of samples of a metric have grown which can be denoted by,

M[t]=[m[0], m[1], . . . , m[t]]

which is to say that the m[t] sample corresponds to a sample of a metric at the current time interval, a second season can be identified and selected from the number of seasons based on the second season having a higher level of correlation with the number of samples that the number of seasons including the first season.

A number of measures of correlation can be used in calculating a correlation between a number of seasons and a number of samples of a metric. In a number of examples of the present disclosure, a season error measure can be used to measure the correlation between a number of season and a number of samples of a metric. A season error measures an absolute deviation of a number of samples from the average of the samples that fall within a number of buckets. The season error can be updated at 214A as denoted by\

Snₜ=alpha·Snₜ₋₁+(1−alpha)·|m[t]−μ[b[Snₜ]]|

wherein Snₜ can denote a season error at a specific time interval such that t can be the current time interval. A season error can be computed at each time interval to provide a point of comparison between a number of seasons in selecting a season at each time interval. At 214a, alpha can be a forget factor, as defined above, that can be used to determine the influence that a sample of a metric at the current time interval can have in calculating a season error. In some examples of the present disclosure, alpha can be calculated through different means than those described above such that alpha can determine the influence that a sample of a metric at the current time interval can have in calculating a season error.

At 214A, b[Snₜ] can include a bucket from a bucket series 230

B[Sn]=[b[0], b[1], . . . , b[Sn]]

wherein the bucket can include the bucket that has been assigned to the time interval t. A number of bucket series, b[0], b[1], . . . , b[Sn], can include a bucket series for each of the number of seasons wherein a bucket series can include a number of buckets that define a season. For example, given a season that corresponds to the season error Sn, b[Sn] can include a bucket series that corresponds to the season wherein the season corresponds to the season error Sn. Furthermore, b[Sn] can include a number of buckets that define a season that corresponds to the season error Sn such that every sample of a metric at any time series falls within one of the number of buckets from the bucket series. At 214A, μ[b[Snₜ]] can include a mean of all of the samples that fall within a specific bucket b[Snₜ] from the bucket series b[Sn].

In an example, when all of the season statistics have been updated at 232, a season with the lowest season error can be selected at 234. The season with the lowest season error can indicate a season that has a highest correlation with a number of samples of a metric. In a number of examples of the present disclosure, a different estimate of correlation can be used and a different method of selecting a season with the highest correlation with a number of samples of a metric can be employed.

A season is selected at 236 and a number of bucket series can be updated at 214B. In a number of examples of the present disclosure, a number of bucket series can also be updated every time a new sample of a metric is received. In some examples of the present disclosure, a bucket series can be updated at different intervals such that the different intervals can include strategic samples of a metric, random samples of a metric, or a different selection of samples of a metric.

In some examples, the number of buckets series can be updated by retaining each of the samples of a metric that has been received and by finding the average at each of the buckets from the number of bucket series each time the bucket series are updated. In a number of examples of the present disclosure, the number of buckets series can be updated in a cumulative fashion. That is, by keeping a sum of the samples of a metric that fall within each of the buckets from the number of bucket series and a count of the samples of a metric that fall within each of the buckets from the number of buckets series. Keeping a sum and a count can provide for a faster update of the bucket series and can allow for each of the samples of a metric to have an influence on the average, e.g., mean, proportional to the deviation of the sample from the current baseline than updating the bucket series by creating an average from historical data at each time series.

At 214B, a sum of the number of samples that fall within each of the buckets from a number of bucket series can be denoted by

Sum[b[Snₜ]]=alpha·Sum[b[Snₜ₋₁]]+(1−alpha)·m[t]w[t].

Sum[b[Snₜ]] denotes the sum of a number of samples of a metric that are assigned to a bucket from the bucket series at the current time interval. Sum[b[Snₜ₋₁d]] denotes the sum, at a previous time interval, of the a number of samples of a metric that are assigned to a bucket from the bucket series at the previous time interval. At 214B, w[t] can denote an influence that a sample, m[t], can have on the sum, Sum[b[Snₜ]], wherein samples with a greater deviation from the current baseline can have a lower weight than samples with a smaller deviation from the current baseline such that

$$w [ t ] = {0.1}^{\vert 2 - \frac{\vert m [ t ] - baseline \_ mean \vert}{baseline \_ sttdev} \vert} .$$

In w[t], baseline_mean can include the baseline mean at the current time interval which can be calculated as described above and baseline_sttdev can include the baseline standard deviation at the current time interval which can be calculated as described above. The count of the samples of a metric that fall within each of the buckets from the number of bucket series can be calculated by,

Count[b[Snₜ]]=alpha·Count[b[Snₜ₋₁]]+(1−alpha)·w[t]

However, in a number of examples of the present disclosure, the sum of the samples of a metric and the count of the samples of a metric can be calculated using different standard such that the sum and the count keep an additive state. An additive state can include using a summary of the number of samples of a metric without having to retain the number of samples of a metric. At 238, the buckets series are updated using the current sample of a metric.

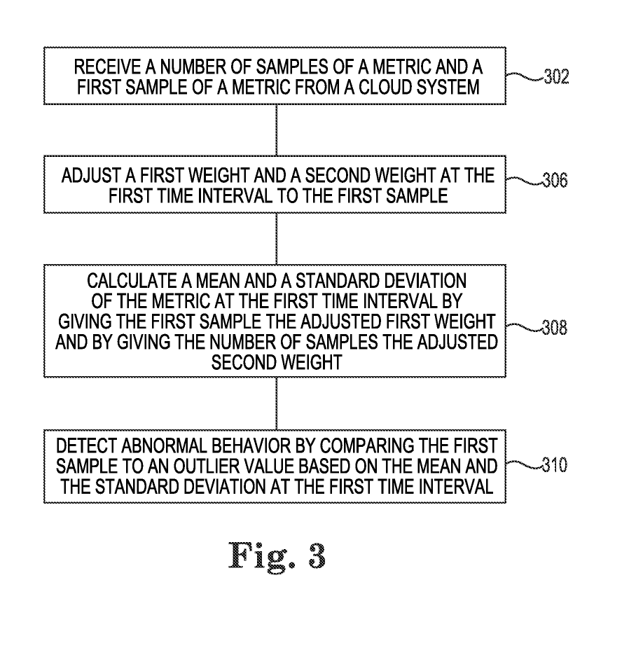

FIG. 3 is a flow chart illustrating an example of a method for detecting abnormal behavior according to the present disclosure. At 302, a number of samples of a metric can be received. The number of samples of a metric can be received from a system and/or an application, wherein a system can include any system that includes a metric that is being monitored for abnormal behavior. At 302, a first sample of a metric can also be received. In some examples of the present disclosure, the first sample of a metric can be received after the number of samples of a metric. The samples can be used in calculating a baseline mean. The first sample of a metric and the number of samples of a metric can be received at separate time intervals such that a sample can be received at every time interval.

At 306, a first weight and a second weight can be adjusted to the first sample of a metric at a first time interval. At each time interval, the first weight and the second weight can be adjusted to the first sample of a metric such that the first weight and the second weight at the first time interval are adjusted from the first weight and the second weight at a previous time interval. For example, a first weight and a second weight at the first time interval t can be adjusted, e.g., updated, from a first weight and a second weight of a previous time interval t−1. In a number of examples of the present disclosure, a first weight and a second weight can determine an influence that a first sample of a metric and a number of samples of a metric, respectively, can have in calculating a baseline mean and a baseline standard deviation at the first time interval, wherein the mean and the standard deviation can be used to detect abnormal behavior in a sample the is received after the first samples. In some examples of the present disclosure, a first weight and a second weight can have a sum of one.

Increasing the first weight and decreasing the second weight can occur when the cloud system reports a system change and/or when the number of samples include a number of consecutive samples that violate a normal distribution at the first time interval. Decreasing the first weight and increasing the second weight can occur when the distance of the first sample from the mean of the number of samples is larger than an outlier value, that is the mean at a previous time interval t−1. Increasing the first weight can give more weight to the first sample and less weight to the number of samples. That is, increasing the first weight and decreasing the second weight can cause the model to forget the number of samples of a metric at a faster rate, while decreasing the first weight and increasing the second weight can cause the model to forget the number of samples of a metric at a slower rate.

At 308, a mean and a standard deviation of the metric at the first time interval can be calculated by giving the first sample an adjusted first weight and by giving the number of samples an adjusted second weight. A mean and a standard deviation at a first time interval can be used to construct a normal distribution at a first time interval that models number of samples and the first sample of a metric. The normal distribution can be used to define normal behavior and to detect abnormal behavior.

At 310, abnormal behavior can be detected by comparing the first sample to an outlier value based on the mean and the standard deviation at a previous time interval. Abnormal behavior can be defined as a sample that is more than outlier value of standard deviations from the mean at a specific time interval. For example, if the first sample is more than three standard deviation from the mean at a previous time interval, then the first sample can be detected as being abnormal behavior. An outlier value can include any number of standard deviations from a mean at a specific time interval.

FIG. 4 is a block diagram illustrating a processing resource 458, a memory resource 460, and a computer readable medium 462 according to the present disclosure. The computer readable medium 462 (e.g., a tangible, non-transitory medium) and/or the memory resource 460 can store a set of instructions executable by the processing resource 458 to receive a number of samples of a metric from a system at a number of time intervals and a first sample of the metric at a first time interval from the system after receiving the number of samples. The instructions can be executed to adjust 406 a first weight and a second weight at the first time interval to the first sample wherein the adjusted first weight and the adjusted second weight determine the influence of the first sample and the number of samples, respectively, in calculating a mean and a standard deviation at the first time interval and wherein the adjusted first weight and the adjusted second weight are influenced by a selected season that models a seasonal behavior of the number of samples of the metric. The instructions can be executed to calculate 408 the mean and the standard deviation of the metric at the first time interval by giving the first sample the adjusted first weight and by giving the number of samples the adjusted second weight. The instructions can be executed to detect abnormal behavior by comparing the first sample to an outlier value based on the mean and the standard deviation at a previous time interval. The instructions can be executed to update 464 a number of buckets that are used in selecting the selected season based on a comparison between a number of potential seasons and the seasonal behavior of the metric.

The number of potential seasons can include the selected season wherein each of the number of samples of the metric and the first sample of the metric can be assigned to the number of buckets. A selected season can be selected based on a comparison between the season error measures of the number of potential season such that the selected season can include the season from the number of seasons with the lowest season error measure. A season error can include defining a number of sets of buckets wherein each of the number of potential seasons can be defined by one of the number of sets of buckets. Each of the buckets from the number of sets of buckets can include an average that can be composed of the number of samples and the first sample that fall within each of the buckets from the number of sets of buckets. Determining the season error measure for each of the number of potential seasons can include keeping a sum of an absolute deviation of the number of samples and the first sample from the corresponding average at each bucket from the number of sets of buckets. In computing a season error measure, outliers in the number of samples and the first sample can be discounted from the season error measure by giving outliers less weight in the season error measure.

The methods, techniques, systems, and apparatuses described herein may be implemented in digital electronic circuitry or computer hardware, for example, by executing instructions stored in computer-readable storage media. Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order and/or in certain combinations, in some implementations, individual operations may be rearranged in a different order, combined with other operations described herein, and/or eliminated, and the desired results still may be achieved. Similarly, components in the disclosed systems may be combined in a different manner and/or replaced or supplemented by other components and the desired results still may be achieved.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method for detecting abnormal behavior comprising:
receiving a mean at a previous time interval, a sum of squares at the previous time interval, and a first sample of a metric at a current time interval from a system;
adjusting a first weight and a second weight at the current time interval to the first sample and a system change report;
calculating a mean and a standard deviation of the metric at the current time interval by assigning the first sample the adjusted first weight and by assigning the mean and the sum of squares at a previous time interval the adjusted second weight; and
detecting abnormal behavior by comparing the first sample to an outlier value based on the mean and the standard deviation at the previous time interval.

2. The method of claim 1, wherein detecting abnormal behavior by comparing the first sample to the outlier value includes the outlier value being a number of standard deviations from the mean at the previous time interval.

3. The method of claim 1, wherein the adjusted first weight includes an alpha variable and the adjusted second weight including a beta variable, wherein the sum of the alpha variable and the beta variable equals one.

4. The method of claim 3, wherein adjusting the first weight and the second weight to the first sample includes increasing the alpha variable and decreasing the beta variable when the system reports the system change and when a number of samples that preceded the first sample include a number of consecutive samples that violate a normal distribution with the mean and the standard deviation at the current time interval.

5. The method of claim 3, wherein adjusting the first weight and the second weight to the first sample includes decreasing the alpha variable and increasing the beta variable when the distance of the first sample from the mean of a number of samples that preceded the first sample is larger than the outlier value.

6. A non-transitory computer-readable medium storing instructions for detecting abnormal behavior executable by a computer to cause the computer to:
receive, from a system, a number of samples of a metric at a number of time intervals and a first sample of the metric at a first time interval after receiving the number of samples;
adjust a first weight and a second weight at the first time interval to the first sample, wherein the adjusted first weight and the adjusted second weight determine the influence of the first sample and the number of samples, respectively, in calculating a mean and a standard deviation at the first time interval;
calculate the mean and the standard deviation of the metric at the first time interval by assigning the first sample the adjusted first weight and by assigning the number of samples the adjusted second weight;
detect abnormal behavior based on the mean and the standard deviation at a previous time interval by comparing the first sample to an outlier value; and
update a number of buckets that are used in selecting the selected season based on a comparison between a number of potential seasons and the seasonal behavior of the metric.

7. The medium of claim 6, wherein the number of potential seasons includes the selected season, and wherein each of the number of samples of the metric and the first sample of the metric are assigned to the number of buckets.

8. The medium of claim 6, wherein the instructions to update a number of buckets that are used in selecting the selected season include instructions to:
determine a season error measure for each of the number of potential seasons; and
select one of the number of potential seasons with a lowest season error measure.

9. The medium of claim 8, wherein the instructions to determine the season error measure for each of the number of potential seasons include instructions to:
define a number of sets of buckets wherein each of the number of potential seasons is defined by one of the number of sets of buckets;
keep an average at each bucket from the number of sets of buckets, wherein the average includes the number of samples and the first sample that are assigned to each of the buckets from the number of sets of buckets; and
determine the season error measure for each of the number of potential seasons by keeping a sum of an absolute deviation of the number of samples and the first sample from the corresponding average at each bucket from the number of sets of buckets.

10. The medium of claim 8, wherein the instructions to determine a season error measure for each of a number of potential seasons include instructions to discount outliers in the number of samples and the first sample from the season error measure by decreasing an outlier weight in the season error measure.

11. An abnormal behavior detecting system, comprising:
a processing resource in communication with a computer readable medium, wherein the computer readable medium includes a set of instructions, and wherein the processing resource is designed to execute the set of instructions to:
receive a number of samples of a metric from a cloud system at a number of time intervals and receive a first sample of the metric at a first time interval from the cloud system after receiving the number of samples;
adjust a first weight and a second weight at the first time interval to the first sample wherein the adjusted first weight and the adjusted second weight determine the influence of the first time interval and the number of samples, respectively, in determining a mean and a standard deviation at a first time interval;
calculate the mean and the standard deviation of the metric at the first time interval by giving the first sample the adjusted first weight and by giving the number of samples the adjusted second weight;
detect abnormal behavior by comparing the first sample to a threshold number of standard deviations from the mean at a previous time interval; and
periodically update a number of buckets used in selecting a selected season and in adjusting a first weight and a second weight wherein selecting the selecting season is based on a comparison between a number of potential seasons and a seasonal behavior of the metric.

12. The system of claim 11, wherein the instructions are further executed to adjust the first weight and the second weight to the first sample based upon a frequency of the metric and the selected season.

13. The system of claim 11, wherein the instructions are further executed to increase the first weight and decrease the second weight when the cloud system reports a system change and when the number of samples includes a number of consecutive samples that violate a normal distribution with the mean and the standard deviation at the first time interval.

14. The system of claim 11, wherein the instructions are further executed to decrease the first weight and increase the second weight when the distance of the first sample from a baseline mean is larger than an outlier value wherein the baseline mean is a mean of the metric at a time interval that preceded the first time interval.

15. The system of claim 14, wherein the instructions are further executed to:
decrease the first weight to the lower of a threshold value or a value that depends on the first weight and on the distance of the first sample from the baseline mean; and
increase the second weight, wherein the sum of the first weight and the second weight equals one.
